(19) United States
(12) Patent Application Publication
(10) Pub. No.: US 2026/0340716 A1
(43) Pub. Date: Oct. 29, 2026

(54) Dynamic Computerized User Interface

(71) Applicant: Kindly Tech, Inc., Saint Paul, MN (US)

(72) Inventor: Brandon Litman, Minneapolis, MN (US)

(73) Assignee: Kindly Tech, Inc., Saint Paul, MN (US)

(21) Appl. No.: 19/659,536

(22) Filed: Apr. 27, 2026

Related U.S. Application Data
(60) Provisional application No. 63/796,086, filed on Apr. 28, 2025.

(51) Int. Cl. G06Q 30/0601; G06Q 20/40

(52) U.S. Cl. CPC G06Q 30/06444; G06Q 20/407

(57) ABSTRACT

A computer-implemented method facilitates gamified donation matching through a centralized treasury and ledger system utilizing a user interface with a gamified visualization. A matching grant is received from a first donor, conditioned on specific triggers such as volunteer engagement or donation behavior. A second donor submits a donation request via a user interface, which initiates a gamified element—such as a spinning wheel—to reveal a match value. If the user delays or cancels, a warning is shown indicating the match may be forfeited. Upon completion, matched funds are released to the nonprofit. The system employs randomized or behavior-optimized logic, optionally enhanced by machine learning, and integrates with third-party platforms. Conditional logic governs fund release, with matching triggered by defined user attributes or actions. Dashboards enable donors, nonprofits, and administrators to track funds and engagement.

### TECHNICAL FIELD

The present invention relates to a dynamice computerized user interface of the type that might be used for financial technology (fintech) platforms designed for charitable giving. More specifically, it relates to computerized user interfaces for conditional, gamified, and socially interactive donation matching through a centralized treasury and ledger model.

### BACKGROUND

Traditional methods of nonprofit fundraising rely heavily on direct appeals, donor relationships, or basic matching campaigns that serve primarily as marketing tools, with no actual automated or digital mechanism linking the original donation to the matched funds. In many cases, the ‘match’ is fulfilled manually behind the scenes, with nonprofits adjusting internal accounting to reflect the story told to donors. However, such approaches often lack interactivity, personalization, and real-time responsiveness. Additionally, the user interfaces that provide user access to existing donor-advised fund (DAF) structures are static, providing minimal opportunities for donor engagement once the funds are placed and advised. There is a need for a user interface that dynamically engages prospective donors and aligns giving incentives with social interaction, gamification, and outcome-based matching.

Traditional user interfaces frequently fail to effectively guide users through the donation process, often resulting in incomplete transactions. This issue, commonly referred to as "donor drop-off," mirrors the challenges faced in ecommerce platforms with abandoned shopping carts. Despite numerous efforts to address these inefficiencies, many user interface designs remain inadequate at ensuring transaction completion. For example, some platforms have implemented progress bars to visually indicate how close users are to completing their donations or purchases, aiming to create a sense of urgency or accomplishment. Others have added pop-up reminders or notifications prompting users to return and finish their transactions. Additionally, personalized follow-up emails are often employed to re-engage individuals who have started but not completed their donation process. While these approaches have provided marginal improvements, they have not fully resolved the issue of drop-off rates, highlighting the need for more innovative and engaging solutions.

### SUMMARY

The invention provides a software-based platform with user interfaces that facilitate dynamic donation matching between prospective donors ("transactional donors") and committed donors ("Kindly Fund donors"). The system and its interfaces allow Kindly Fund donors to pre-fund donation pools through either specific nonprofit designations or thematic programmatic causes. Transactional donors unlock these funds through defined trigger conditions (e.g., completing volunteer hours or initiating a donation), creating an engaging experience amplified by gamified visual elements. The interface creates a connection between the Transactional Donor and the Kindly Fund Donor, therefore reinforcing several important behavior motivations, such as social proofing, to increase the likelihood of completing the donation. All funds are centrally managed in a pooled treasury governed by a proprietary ledger and matching algorithm.

The interface and core mechanics (donation input, gamified funds-matching, donor retention mechanics) are also accessible to Transactional donors organically discovering the donation forms, including through 3^{rd} party website embeds (the nonprofit). Meaning, the interface and donation matching experience can be engaged without a pre-requisite activity aside for inputting an initial donation as a Transactional Donor, thus unlocking a match from Kindly Fund Donors throughout the internet and other digital means.

The present invention creates a new, dynamic user interface in order to address the problem of transaction completion that was found in prior art user interfaces. The interface uses a two-part method that first institutes a match for the donation process. The match involves some element of luck or randomization. This matching step allows a user to feel that their decision to donate a certain amount will trigger an actual donation to the recipient of an amount greater than their individual donation. The amount greater is determined by this element of luck. The second part of the method is to remind users that the determination of the donation will be lost if they fail to complete the transaction in due course. For instance, if the user selects to return to a previous screen (such as to the “amount of donation” screen or the “select a recipient” screen), they will lose their match. They may be allowed to create a new match (spin the wheel again), but this new match may not result in as high of an effective donation. This offers resistance to leaving the donation incomplete. The notification of the lost match could also be presented if a user otherwise tries to leave a screen before the completion of the donation, or if a time period has expired.

### BRIEF DESCRIPTION OF THE DRAWINGS

FIG. 1 is a first screen shot of a user interface.

FIG. 2 is a second screen shot of the user interface of FIG. 1.

FIG. 3 is a third screen shot of the user interface of FIG. 1.

FIG. 4 is a fourth screen shot of the user interface of FIG. 1.

FIG. 5 is a fifth screen shot of the user interface of FIG. 1.

FIG. 6 is a sixth screen shot of the user interface of FIG. 1.

FIG. 7 is a seventh screen shot of the user interface of FIG. 1.

FIG. 8 is an eighth screen shot of the user interface of FIG. 1.

FIG. 9 is a ninth screen shot of the user interface of FIG. 1.

FIG. 10 is a screen shot of a second embodiment.

FIG. 11 is a flow chart of a method.

### DETAILED DESCRIPTION

### User Interface Improvements

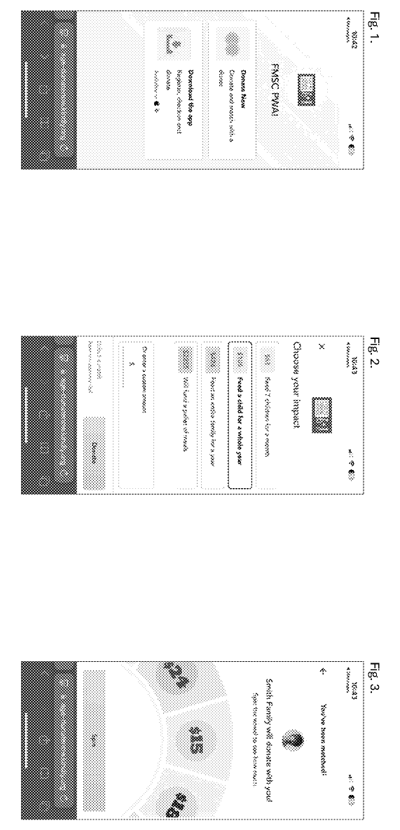

FIGS. 1 through 9 present an improved user interface for seeking donations. The two-part method previously outlined involves an innovative approach where the interface enables dynamic interaction with system components. The first part emphasizes the structuring of core features to streamline user engagement, while the second part involves integrating adaptive feedback mechanisms that evolve based on user input. These foundational principles are demonstrated visually across FIGS. 1 through 9, showcasing progressive enhancements and the intuitive nature of the design.

In FIG. 1, a Transaction Donor (“User”) starts at welcome screen. If the donation solicitation has a time expiration component, this screen might instruct the user to take an action to reauthorize the donation matching opportunity. At FIG. 2, the user can select a predefined amount for a donation. Notice that the options presented include both a currency amount (such as $106) and an impact statement, that provides a written description of what might be accomplished by the recipient with that donation. Other visual components maybe used, including photos, animation and conditional values based on user inputs and/or audience segmentation. The user can also input a custom donation value and a respective impact will be calculated. In some embodiments, crypto donations are possible. Crypto wallets can be identified in these embodiments, and smart contracts can be used to unlock matches, create matches, and complete the donations.

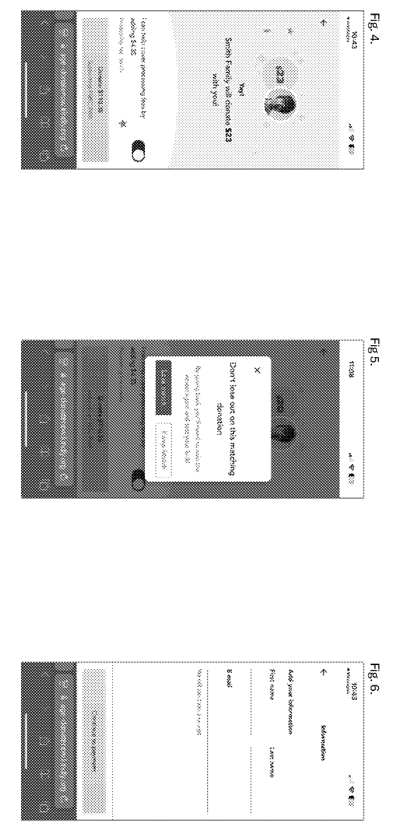

Upon inputting the donation amount, the user will be matched with a donor who has a Fund connected to the Kindly platform. This is shown in FIG. 3. The user will interact with a gamified dynamic element to unlock funds from that matching donor. In this visualization, the user interface is a spinning wheel. After engaging with the gamified element, the user is informed of the matching donation value, as shown in FIG. 4. The user can also authorize a donation increase to include payment processing fees in their donation.

If the user attempts to go backwards, they are informed that they will lose the current matching value and will have to “spin again,” or take an additional action to unlock the additional donation match. This is seen in FIG. 5. The Kindly user funnel creates resistance for transactional donors to abandon their original donation.

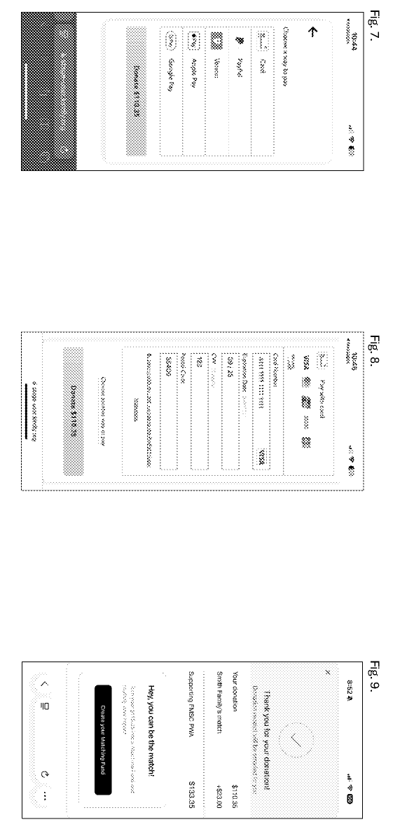

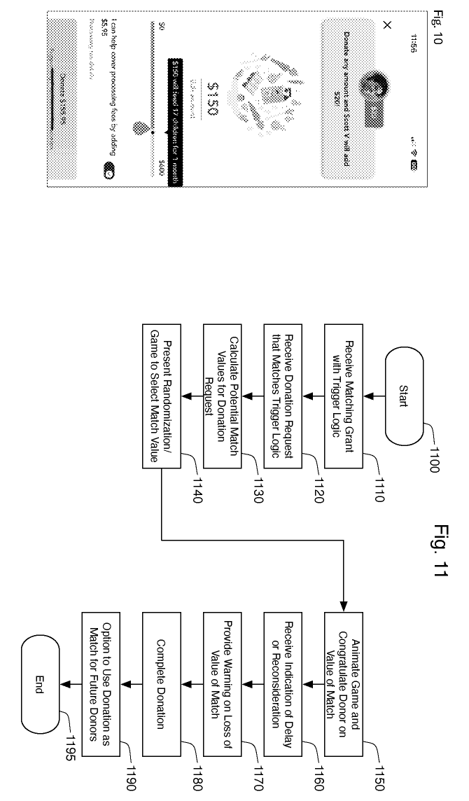

Assuming the user chooses to go ahead with the donation, the user inputs contact information using the interface shown in FIG. 6, which will also be used for an automated tax receipt sent to the user’s email. As part of the donation process, the user also inputs preferred payment method (FIG. 7) and inputs payment details (FIG. 8). When the donate button is selected in FIG. 8, FIG. 9 will present a confirmation screen that shows the total amount of funds being deployed in support of the nonprofit (user donation + donation match).

The confirmation screen (FIG. 9) presents an option for the user to convert the donation they just made into a Kindly Fund. The presentation of this option is based on various conditions, such as donation amount, donor demographic data, and other factors. This presentation creates an immediate opportunity to convert a Transactional Donor into a Kindly Fund Donor. If the user agrees to use their donation as a Kindly Fund, they are sent a link through the website, email, SMS, or other communication methods to access their Kindly Fund account. This step enriches and extends the donation experience through administrative dashboards that visualize impact as a matching donor.

FIG. 10 shows an alternative embodiment, where a donor is be matched to a fixed amount to simplify the journey and call-to-action. As shown here, the Kindly Fund Donor is visualized (top of screen) in the same screen that the Transaction Donor inputs their donation value, in this case on a “sliding” line, with donation impact represented by way of milestones on that line. In this example, the matched amount is not variable and the Call to action to Transactional Donors is based on a clear reward (matched amount), enticing them not to lose that amount by inaction. However, such an alternative fails to provide the gamification of FIGS. 3 and 4, and therefore the informational element shown in FIG. 5 cannot warn of losing the value of the match in the same way. As a result, the embodiment in FIG. 10 does not present as large of an incentive to complete the donation transaction.

FIG. 11 shows a flow chart showing a method 1100 for implementing the process described in connection with FIGS. 1-9. The method 1100 starts at step 1110, where a matching grant is received. A matching party, for instance, may agree to provide $1,000, but will provide this amount only if additional donors are found to match that grant. There is no need for a one-to-one match. Matching grant donors may specify conditions and limits on how their Kindly Funds are unlocked. In other words, not all donations to the same recipient may unlock a matching fund. Trigger logic can be time-based, behavior-based, or achievement-based. Matching is triggered based on donor attributes including but not limited to geography, donation history, cause alignment, timing, and volunteer engagement. Matching events are designed to optimize donor participation and conversion. For example, it may be that only donation request of a particular amount are accepted to trigger a match through method 1100. Alternatively, only donation requests made after volunteering (or during a volunteer event) are accepted to trigger the matching of method 1100. These conditions may include:
Completion of volunteer hours
Donation by a transactional donor
Social promotion or peer-to-peer advocacy
QR code scanning at events
Event attendance check-in
Engagement-based gamification (e.g., email sharing, referring new donors)

At step 1120, a second donor submits a request to make a donation that matches the trigger logic for the matching grant. This is likely a request to donate a significantly smaller amount than the matching grant received at step 1110. At step 1130, a variety of potential match values are calculated. These values are based on the received request from step 1120, and may also be based upon parameters associated with the matching grant received at step 1110. For example, the potential match values may range from 5% of the amount indicated at step 1120 (or even less) to 50% of that amount (or more).

At step 1140, the potential match values are presented in a visual manner to the user that submitted the donation request at step 1120. In FIG. 3, these potential match values are presented on a spinning wheel. In order to increase the visual size of the numbers, only a portion of the virtual wheel is shown in FIG. 3. The user is then provided with a user interface element to “play the game” such as by spinning the wheel. This is shown in FIG. 3 with the “Spin” button. When this interface element is selected, the user interface will animate the game, such as by spinning the wheel. Other animations are possible, such as throwing a dart against a target, or by popping virtual balloons to reveal a hidden match, card flips, countdowns, unlocking animations, etc.

This animation takes place in step 1150. At the end of this step, the animation will conclude and a match value will be selected. The system uses randomized and optimized logic to determine the unlocked donation value. Machine learning is used to improve the matching engine's performance based on historical donor behavior and engagement outcomes. In the preferred embodiment, the user interface will immediately congratulate the user on the match value, which is shown in FIG. 4 (and is also performed as part of step 1150).

At step 1160, the system receives an indication of delay or reconsideration. The user, for instance, may choose to go back to a previous page (if the interfaces shown in FIG. 1-9 are presented as web pages, for instance). Alternatively, the user may select a “cancel” button, or simply delay the completion of the donation for a set period of time. When this indication is received in step 1160, the system responds by presenting a warning on the loss of the match value at step 1170. This is shown in FIG. 5. Assuming the user elects to keep the match and proceed with the donation, this occurs at step 1180. At step 1190, the donation is submitted and the user may be presented with an option to use the donation as a match for future donors. This is shown in FIG. 9. The method 1100 then completes at step 1195.

Transactional donors interact through a mobile app, a web site, or a plug-in. In a preferred embodiment, notifications are provided to prompt Transactional Donors to provide a donation request at step 1120 that will trigger a match whenever matching funds are available and after the criteria required for the match occurs (e.g., after volunteering). The gamified component shown in FIGS. 3 and 4 is interactive. Furthermore, this is not available to the individual donors unless a matching grant has been received (at step 1110), and a Transactional Donor is available (at step 1120), which enhances engagement in the donation process. Messaging encourages donors to share their impact on social media, which may be used as an additional trigger or reward system.

Alternative embodiments are possible using these general user interfaces and method 1100. For example, custom fund matching thresholds can be created. Gamified storytelling is also possible, where unlocking stories or missions are provided before matches are available. AI can be used to help with this storytelling. With advanced AI capabilities, personalized stories, and personalized congratulations and other media can be created and tied to donation milestones. Employer and workplace matching programs are also possible that link internal fund structures to group goals. Real-time impact feeds or donor leaderboards can also be provided. It is also possible to integrate the system with CRM and volunteer management systems (or other nonprofit software platforms or accounting platforms) for seamless user journey.

Some example use cases where the above interfaces and method 1100 can be utilized include:
John Smith, who desires to set up a "Helping Hands Fund" for a specific nonprofit. When a volunteer at Helping Hands makes a donation after an event, funds from John’s Kindly Fund are unlocked via a spinning wheel visual.
Carol Rogers, who support five nonprofits. Each of these nonprofits is supported with a different, unique Fund. Her dashboard shows collective impact and individual fund performance.
Joe Clinton uses the Kindly Community Fund to support causes broadly. His preferences define how the algorithm allocates funds to aligned nonprofits based on real-time donor engagement patterns.

Administration dashboards are available for this system. A donor dashboard for those individuals that provide the matching grant (step 1110) provides real-time visualization of fund balances, grants, donor activity, and unlocked matches. This supports multiple fund views for donors supporting several nonprofits. A nonprofit dashboard is also available that shows donations received, funds available to unlock, and engagement metrics from both donor types. These dashboards may include downloadable reports and export tools for compliance, impact analysis, and board reporting. These dashboard are accessible to users based upon their role. Example roles that can be established include:
Kindly Fund Donor (aka, Matching Grant Donor at step 1110): Can create and fund Kindly Funds and view dashboards.
Transactional Donor (aka, User who submits donation request at step 1120): Participates in matching events and gamified donation triggers, often through volunteering and or donating.
Nonprofit Admin: Views performance and matching reports, configures appeals, and receives unlocked funds.
Platform Admin: Manages treasury rules, monitors fraud detection, and configures matching algorithms.

### Current State of Donation Matching

Traditional donation matching campaigns and tools lack dynamic fund distribution mechanics, integrated social functionality, and automated community impact retention mechanisms for the original matching donor (referred to as the Matching Grant Donor at step 1110). In most cases, matching campaigns rely on informal verbal commitments from larger donors, often used as a marketing tool, with little accountability or assurance of real, “bankable” funds.

The practice of donation matching has faced criticism as a potentially misleading marketing tactic. It often suggests that donations will be “doubled,” when in reality the matching funds have already been committed. This can overstate the perceived impact of individual contributions and may erode donor trust.

Research indicates that while matching campaigns can increase donation rates, they may also lead to unintended consequences. For example, donors might reduce the size of their contributions under the assumption that smaller amounts are more impactful when matched.

The authenticity and transparency of matching funds are critical. If the matching funds are not genuinely contingent on new donations, the campaign may mislead donors. Clearly disclosing the source and conditions of matching funds is essential to maintaining donor confidence and trust.

### Fund Structure and Treasury Model

One embodiment of the present invention addresses the shortcomings in the current market by establishing a unique treasury model that requires real funds to be deposited and held until a donation match or other defined condition is met (Complete Donation, at step 1180). The platform’s gamification features have been shown to increase both donation value and frequency. The promise of real funds being unlocked, coupled with the model’s sophisticated call-to-action, often connected to specific and related actions that are connected to social interactions or behavior markers for generosity, drive donation engagement and create a unique experience for both the transactional donor (that submitted the request at step 1120) and the matching grant donor.

The model, as outlined in Method 2 below, enables more matching capital to reach nonprofit causes by allowing donors to allocate funds based on impact areas and programmatic interests, rather than limiting them to specific institutions. This approach resonates with the next generation of donors, who tend to prioritize causes over organizations. Unlike traditional Donor-Advised Funds (DAFs), this model ensures automatic distribution of funds to charities at a defined velocity. This automation addresses a growing criticism of DAFs—namely, their illiquidity and failure to deploy philanthropic capital that has already provided the donor with a tax benefit.

In one embodiment, donors may set up funds using three primary modes:
Method 1: Donate to a specific nonprofit with funds deposited into a bank account held FBO (for the benefit of) the nonprofit. Funds are pooled and tracked using a centralized treasury and ledger system.
Method 2: Donate to a Community Fund, Inc. (a sponsoring nonprofit), to allow algorithmic allocation to various nonprofits based on preferences and market conditions.
Method 3: Donate to multiple nonprofits with specific budgets allocated to each. Each nonprofit receives funds directly in an FBO account, and the donor sees performance across all funds in a single dashboard.

Treasury accounts are created at the bank level with proper KYC vetting. Funds are not immediately disbursed; their availability is controlled algorithmically based on conditional logic. The platform supports override and discretionary controls by system administrators.

The system is built on Pay Theory's treasury infrastructure but is adaptable to other embedded banking providers. All transactions are reconciled using an internal ledger, which monitors available vs. conditional balances. APIs and SDKs are available to integrate the present system’s functionality into third-party applications and nonprofit websites. Compliance and data privacy are maintained through secure encryption, audit logs, and adherence to PCI-DSS and GDPR where applicable.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A computer-implemented method for dynamic donation matching using gamified interaction, comprising:
a) receiving, by a server system, a matching grant from a first donor, the matching grant being associated with a condition for fund release;
b) receiving, from a second donor via a user interface, a donation request to a charitable organization with a donation amount;
c) determining, by the server system, that the donation request satisfies the condition for fund release;
d) calculating a plurality of potential match values based on the donation amount;
e) presenting, via the user interface, a gamified visualization of the potential match values;
f) receiving, via the user interface, a user input triggering the gamified visualization to animate and select a selected match value, wherein the gamified visualization involves moving elements that determine the selected match value;
g) displaying, on the user interface, the selected match value after completion of the animation;
h) detecting an indication of delay or cancellation by the second donor;
i) displaying, in response to the detection, a notification indicating that the selected match value will be forfeited unless the donation is completed within a prescribed timeframe; and
j) processing, by the server system, the donation and releasing the selected match value to the charitable organization upon completion of the donation by the second donor.

2. The method of claim 1, further comprising:
k) determining, by the server system, after completion of the donation, whether the initial donation satisfies one or more conditions for conversion into a matching fund;
l) presenting, via the user interface, in response to the determining, an option to convert the initial donation into a matching fund, and receiving, via the user interface, a user input indicating acceptance of the option; and
m) updating, by the server system, a financial ledger to reclassify the initial donation as a matching fund and to govern subsequent conditional release of the matching fund.

3. The method of claim 1, wherein the indication of delay or cancellation comprises navigating away from the donation interface, selecting a cancel option, or exceeding a predetermined timeout period.
